(19) United States
(12) Patent Application Publication
(10) Pub. No.: US 2013/0294322 A1
(43) Pub. Date: Nov. 7, 2013

(54) APPARATUS AND METHOD FOR SEQUENTIALLY TRANSMITTING DATA

(71) Applicant: Electronics And Telecommunications Research Institute, (US)

(72) Inventors: Mi Young YUN, Daejeon (KR); Hyun LEE, Daejeon (KR); Seokki KIM, Gyeonggi-do (KR); Won-Ik KIM, Daejeon (KR); Chul Sik YOON, Daejeon (KR); Sung Cheol CHANG, Daejeon (KR)

(73) Assignee: ELECTRONICS AND TELECOMMUNICATIONS RESEARCH INSTITUTE, Daejeon (KR)

(21) Appl. No.: 13/886,655

(22) Filed: May 3, 2013

(30) Foreign Application Priority Data
May 4, 2012 (KR) 10-2012-0047650
Mar. 28, 2013 (KR) 10-2013-0033579

(51) Int. Cl. H04W 80/08

(52) U.S. Cl. CPC H04W 80/08
USPC 370/312; 370/329; 370/315

(57) ABSTRACT

A reception terminal receives information indicating whether a service flow requires in-order delivery and a maximum time during which data not yet received is to wait in a case in which in-order delivery is required, from a transmission terminal, restores service data units (SDUs) from protocol data units (PDUs) received from the transmission terminal with respect to the corresponding service flow, and transmits the restored SDUs to a higher layer according to sequence numbers of the received PDUs in order.

### CROSS-REFERENCE TO RELATED APPLICATION

This application claims priority to and the benefit of Korean Patent Application Nos. 10-2012-0047650 and 10-2013-0033579 filed in the Korean Intellectual Property Office on May 4, 2012 and Mar. 28, 2013, the entire contents of which are incorporated herein by reference.

### BACKGROUND OF THE INVENTION

(a) Field of the Invention

The present invention relates to a method for sequentially transmitting data, and more particularly, to a method for sequentially transmitting data to a higher layer by a reception terminal in direct communications between terminals.

(b) Description of the Related Art

A method of establishing a direct communication link between terminals by utilizing a particular resource domain in an infrastructure communication-based environment configured between a terminal and a base station (BS) has been proposed by an IEEE 802.16 Greater Reliability in Disrupted Metropolitan Area Networks (GRIDMAN) task group.

A medium access control (MAC) is required to support a function of sequentially transmitting medium access control service data units (MAC SDUs) according to service characteristics, but the current standard does not take this into consideration.

### SUMMARY OF THE INVENTION

The present invention has been made in an effort to provide a method for sequentially transmitting data having advantages of sequentially transmitting media access control service data units (MAC SDUs) to a higher layer in direct communication between terminals.

An exemplary embodiment of the present invention provides a method for sequentially transmitting data to a higher layer in a reception terminal. The data transmission method may include: receiving an in-order delivery indicator indicating whether a service flow requires in-order delivery and a maximum time during which a node is to wait for data not yet received when in-order delivery is required, from a transmission terminal; restoring service data units (SDUs) from protocol data units (PDUs) received from the transmission terminal with respect to the service flow; and transmitting the restored SDUs to the higher layer in order according to sequence numbers of the received PDUs.

The data transmission method may further include, when there is a PDU not yet received from the transmission terminal, the maximum time may be awaited.

The receiving may include receiving a link establishment request message for establishing a link from the transmission terminal, wherein the link establishment request message may include the in-order delivery indicator and the maximum time.

The data transmission method may further include transmitting a link establishment response message with respect to the link establishment request message to the transmission terminal.

The receiving of the link establishment request message may include receiving a request to send (RTS) message indicating that data transmission from the transmission terminal is desired, the transmitting of the link establishment response message may include transmitting a clear to send (CTS) message indicating approval of the data transmission to the transmission terminal, the link establishment request message may be piggybacked to the RTS message, and the link establishment response message may be piggybacked to the CTS message.

The link establishment may include unicast link establishment.

The receiving may include receiving a link establishment command message for establishing a link from the transmission terminal, and the link establishment command message may include the in-order delivery indicator and the maximum time.

The receiving of the link establishment command message may include receiving an RTS message indicating that data transmission is desired from the transmission terminal, and the link establishment request message may be piggybacked to the RTS message.

The link establishment may include broadcast and multicast link establishment.

The receiving may include receiving a service setting message from the transmission terminal, and the service setting message may include the in-order delivery indicator and the maximum time.

The data transmission method may further include requesting release of the link connection established between the transmission terminal and the reception terminal.

Another embodiment of the present invention provides a method for sequentially transmitting data to a higher layer in a reception terminal. receiving an in-order delivery indicator indicating whether a service flow requires in-order delivery and a maximum time during which a protocol data unit (PDU) not yet received is to wait in a case in which in-order delivery is required, from a transmission terminal via a relay; restoring service data units (SDUs) from protocol data units (PDUs) received via the relay with respect to the service flow; and transmitting the restored SDUs to the higher layer in order.

The receiving may include receiving a target of in-order delivery from the transmission terminal via the relay.

The restoring may include, when the target of the in-order delivery is the relay, receiving PDUs generated again in sequence of SDUs from the relay which has received the PDUs transmitted by the transmission terminal.

The restoring may include, when the target of the in-order delivery is the reception terminal, receiving the PDUs transmitted from the transmission terminal via the relay, and restoring SDUs from the received PDUs and sorting the restored SDUs in order.

The restoring may further include, when there is a PDU not yet received from the transmission terminal via the relay, waiting the maximum time.

The receiving may include receiving a link establishment request message for establishing a unicast link from the relay which has received a relay request message from the transmission terminal, wherein the relay request message and the link establishment request message may include the in-order delivery indicator and the maximum time, respectively.

The data transmission method may further include transmitting a link establishment response message with respect to the link request message to the relay, wherein when a link establishment between the relay and the reception terminal is completed, the PDU may be transmitted from the transmission terminal.

The receiving may include receiving a link establishment command message for establishing a broadcast and multicast links from the relay which has received a relay request message from the transmission terminal, wherein the relay request message and the link establishment command message may include the in-order delivery indicator and the maximum time, respectively.

The data transmission method may further include transmitting a reception acknowledgement message with respect to the link establishment command message to the relay, wherein when a link establishment between the relay and the reception terminal is completed, the PDU may be transmitted from the transmission terminal.

### BRIEF DESCRIPTION OF THE DRAWINGS

FIG. 1 is a view illustrating an example of medium access control service data units (MAC SDU) according to an embodiment of the present invention.

FIG. 2 is a view illustrating an example of a method for transmitting data in direct communication between terminals according to an embodiment of the present invention.

FIG. 3 is a view illustrating a method for establishing a one-hop unicast connection for sequential data transmission according to an embodiment of the present invention.

FIG. 4 is a view illustrating a method for releasing a unicast connection according to an embodiment of the present invention.

FIG. 5 is a view illustrating a method for establishing a one-hop broadcast and multicast connection for sequential SDU transmission according to an embodiment of the present invention.

FIG. 6 is a view illustrating a method for establishing a two-hop unicast connection for sequential SDU transmission according to an embodiment of the present invention.

FIG. 7 is a view illustrating a method for establishing a two-hop broadcast and multicast connection for sequential SDU transmission according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Throughout the specification, a terminal may refer to a mobile station (MS), a mobile terminal (MT), a subscriber station (SS), a portable subscriber station (PSS), user equipment (UE), an access terminal (AT), or the like, and may include the entirety or a portion of functions of the terminal, the MT, the SS, the PSS, the UE, the AT, and the like.

Throughout the specification, a repeater may refer to a base station (BS), an access point (AP), a radio access station (RAS), a node B, an evolved node B (eNodeB), a base transceiver station (BTS), a mobile multihop relay (MMR)-BS, and the like, and may include the entirety or a portion of functions of the AP, the RAS, the node B, the eNodeB, the BTS, the MMR-BS, and the like.

A data transmission apparatus and transmission method according to embodiments of the present invention will be described in detail with reference to the accompanying drawings.

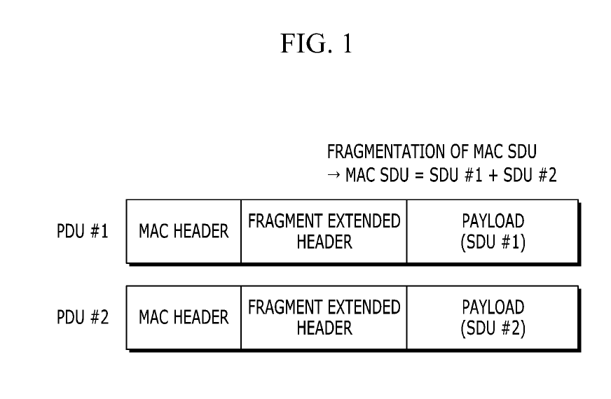

FIG. 1 is a view illustrating an example of medium access control service data units (MAC SDU) according to an embodiment of the present invention.

In general, a medium access control protocol data unit (MAC PDU) includes a MAC header and a payload. The payload may include a MAC service data unit (MAC SDU). The payload may further include a cyclic redundancy check (CRC).

Here, when a MAC SDU is too long to configure a single MAC PDU, the MAC SDU is fragmented into two or more SDUs (SDU #1 and SDU #2), and, as illustrated in FIG. 1, the fragmented SDUs (SDU #1 and SDU #2) are respectively transmitted by MAC PDUs (PDU #1 and PDU #2).

In this manner, in preparation for the case in which a MAC SDU is fragmented, a fragment extended header is used for the purpose of ascertaining whether or not MAC PDUs are missing. Namely, a MAC PDU further includes a fragmented extended header.

The fragment extended header includes a sequence number of a MAC PDU. The sequence number of a MAC PDU is used to assemble MAC SDUs in an accurate sequence.

For example, a MAC SDU is fragmented in order of SDUs (SDU #1 and SDU #2) and transmitted by MAC PDUs (PDU #1 and PDU #2), respectively, and sequence numbers of the MAC PDUs (PDU #1 and PDU #2) are assigned as values indicating fragmentation order.

A reception terminal may check sequence numbers of the MAC PDUs (PDU #1 and PDU #2), arrange them in order of the SDUs (SDU #1 and SDU #2), and transfer them in the order of SDUs (SDU #1 and SDU #2) to a higher layer.

Meanwhile, even when a MAC SDU is not fragmented, a sequence number of a MAC PDU may be used, and even in a case of a short packet, a sequence number may be defined even in a short packet MAC header (SPMH) header used therein to check whether a MAC PDU is missing.

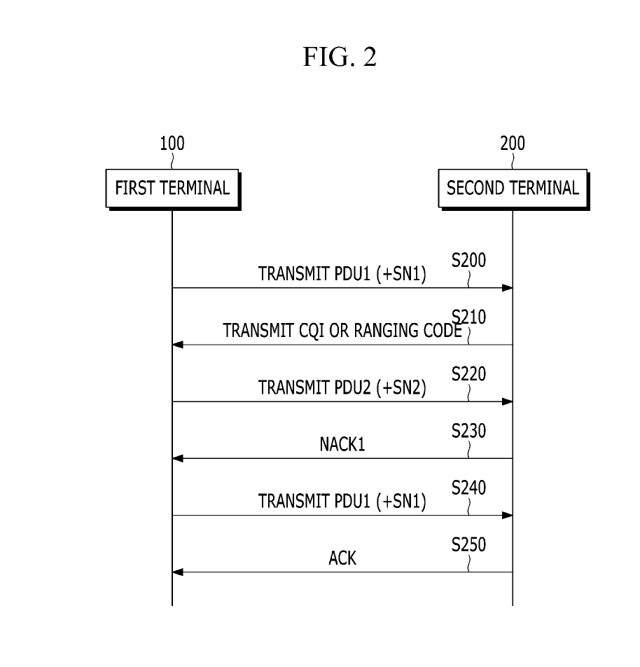

FIG. 2 is a view illustrating an example of a method for transmitting data in direct communication between terminals according to an embodiment of the present invention.

Referring to FIG. 2, a first terminal 100 transmits a PDU (hereinafter referred to as “PDU1”) having a first sequence number SN1 to a second terminal 200 in a current communication frame (S210).

In general, a reception terminal receiving a data packet, i.e., a PDU, uses a hybrid automatic repeat request (HARQ) scheme for securing reliability of communication. According to the HARQ method, the reception terminal decodes a received PDU to check whether there is an error, and when no error is generated, the reception terminal transmits an acknowledgement (ACK) signal as a response signal to inform a transmission terminal about successful reception of the PDU. However, in a case in which an error is detected when the received PDU is decoded, the reception terminal transmits a negative acknowledgement (NACK) signal as a response signal to inform a transmission terminal about the detection of the error, and upon receiving the NACK signal, the transmission terminal re-transmits a PDU.

The second terminal 200 also uses such a HARQ scheme.

When the PDU1 is received, the second terminal 200 decodes the PDU1 and transmits a HARQ result of an ACK or NACK signal according to whether there is an error. However, as illustrated in FIG. 1, in a case in which the second terminal 200 transmits a periodic CQI, a ranging code, or the like (S210), the second terminal 200 cannot transmit a HARQ result.

Although the first terminal 100 has not received a HARQ result from the second terminal 200, the first terminal 100, regarding it as an ACK signal, transmits a PDU (hereinafter referred to as “PDU2”) having a second sequence number (SN2) in a next communication frame (S220).

When the PDU2 is received from the first terminal 100, the second terminal 200 decodes the PDU2 and transmits a HARQ result of a NACK signal.

In this case, in the state in which the second terminal 200 does not transmit a HARQ result with respect to the first PDU1 to the first terminal 100, if the HARQ result of the PDU1 corresponds to NACK and the HARQ result of the PDU2 corresponds to ACK, the second terminal 200 transmits a HARQ result of a previous frame, namely, a NACK signal of the previous frame, to the first terminal 100. When transmitting the NACK signal of the previous frame, the second terminal 200 transmits a number of the frame in which NACK occurred. As for the used frame number, starting from the mostly recently received frame as a 0^{th} frame, the number is increased by 1 for each subsequently received frame. For example, in case of FIG. 2, the HARQ result with respect to the PDU2 is ACK and the HARQ result with respect to the PDU1 transmitted immediately before PDU2 is NACK, the NACK signal (NACK1) having a frame number 1 set therein is transmitted to the first terminal 100 (S230).

Upon receiving the NACK signal (NACK1), the first terminal 100 re-transmits PDU1 (S240).

When the second terminal 200 receives the PDU1 re-transmitted from the first terminal 100, the second terminal 200 transmits a HARQ result with respect to the PDU1 to the first terminal 100. When there is no error according to decoding results of the PDU1, the second terminal 200 transmits an ACK signal as a HARQ result (S250) to inform the first terminal 100 that the HARQ results of PDU1 and PDU2 are successful.

Meanwhile, according to service characteristics, the second terminal 200 should transmit received SDUs to a higher layer in order. Namely, in the case of FIG. 1, the PDUs are received in order of PDU2 and PDU1 by the second terminal 200, but when they are transmitted to a higher layer, corresponding SDUs should be transmitted in order of PDU1 and PDU2.

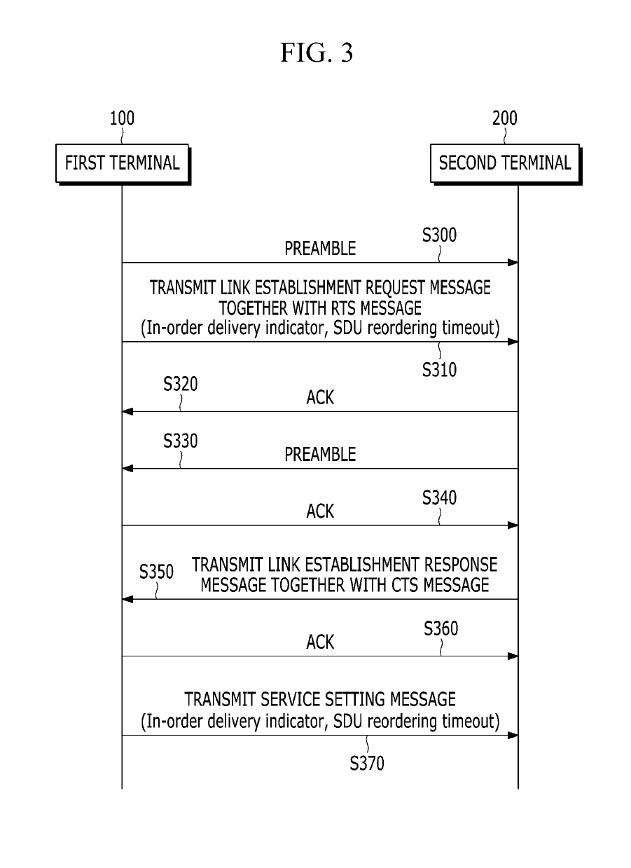

Hereinafter, a transmission method for a case in which SDUs received by the second terminal 200 are transmitted in order to a higher layer according to service characteristics will be described in detail with reference to FIGS. 3 through 7.

FIG. 3 is a view illustrating a method for establishing a one-hop unicast connection for sequential data transmission according to an embodiment of the present invention.

Referring to FIG. 3, the first terminal 100 selects a single direct communication channel by using an interference avoidance algorithm, and starts a procedure of establishing a unicast link with the second terminal 200.

The first terminal 100 transmits a preamble to the second terminal 200 (S300), and transmits a link establishment request message together with an RTS (request to send) message for indicating that data transmission is desired to the second terminal 200 (S310). Namely, the first terminal 100 may transmit a link establishment request message as a piggyback in an RTS message to the second terminal 200.

The link establishment request message may include a service flow setting. The link establishment request message may include an in-order delivery indicator indicating whether a corresponding service flow requires an in-order delivery, and a maximum time (SDU reordering timeout) during which a PDU not received is to be stalled in the case in which the in-order delivery is required. The maximum time (SDU reordering timeout) may correspond to a maximum buffer size for re-sorting SDUs.

In a case in which the corresponding service flow requires the in-order delivery, an in-order delivery indicator may be set to 1, and when the corresponding service flow does not require the in-order delivery, the in-order delivery indicator may be set to 0.

The link establishment request message may include, for example, an AAI-DC-LEST-REQ (Advanced Air Interface-Direct Communication-Link Establishment-Request) message of 802.16.1a/D2 AWD. Table 1 shows an AAI-DC-LEST-REQ message as a link establishment message between direct communication terminals of 802.16.1a/D2 AWD.

As shown in Table 1, the AAI-DC-LEST-REQ message may additionally include the in-order delivery indicator and the maximum time (SDU reordering timeout) with respect to the corresponding service flow for an in-order delivery.

TABLE 1

| | Size | | |
|---|---|---|---|
| Field | (bits) | Value/Description | Condition |
| Link Change | 4 | The change count | Shall |
| Count | | of this transaction | always be |
| | | assigned by the | present |
| | | sender. If a new | |
| | | transaction is | |
| | | started, Link | |
| | | Change Count is | |
| | | incremented by | |
| | | one (modulo 16) | |
| | | by the sender. | |
| For (i=0; | | N_Flow_Est is the | |
| i<N_Flow_Est; | | number of flows on | |
| i++) { | | which the sender | |
| | | of this message | |
| | | sends MAC PDUs. | |
| | | Range [0 . . . 1] | |
| FID | 4 | Flow identifier | |
| | | assigned by the | |
| | | sink of packets on | |
| | | the flow | |
| Traffic Priority | 3 | 0 to 7: Higher | |
| | | numbers indicate | |
| | | higher priority | |
| | | Default: 0 | |
| CS | 8 | 0-15: Reserved | |
| Specification | | 16: Voice Codec | |
| Parameters | | G.729A | |
| | | 17: Voice Codec | |
| | | AMR | |
| | | 18-255: Reserved | |
| MAC Header | 1 | indicates whether | |
| Type | | AGMH or SPMH is | |
| | | presented at the | |
| | | start of MAC PDUs | |
| | | of the service flow. | |
| | | 0: AGMH | |
| | | (Advanced | |
| | | Generic MAC | |
| | | Header) | |
| | | 1: SPMH | |
| | | (Short-packet | |
| | | MAC header) | |
| | | default value is 0. | |
| In-order | 1 | Indicates whether | |
| Delivery | | or not the order | |
| Indicator | | of | |
| | | delivery in the | |
| | | connection is | |
| | | preserved by the | |
| | | MAC. | |
| | | 0: Not preserved | |
| | | 1: Preserved | |
| SDU | 3 | 0 > and <= 8, Unit | Present if |
| Reordering | | is DC frame | In-order |
| Timeout | | | Delivery |
| | | | Indicator |
| | | | is set 1 |
| Reserved | 4 | | |
| } | | | |
| Reserved | | | |

When a link establishment request message is successfully received, the second terminal 200 transmits whether the message has been received, e.g., successful reception (ACK), via an auxiliary channel (S320).

Next, the second terminal 200 transmits a preamble to the first terminal 200 (S330). In direct communication between terminals, a preamble is used for distributed synchronization.

When the preamble from the first terminal 100 is successfully received (ACK) (S340), the second terminal 200 transmits a link establishment response message with respect to the link establishment request message, together with a CTS (clear to send) message for indicating approval of data transmission, to the first terminal 100 (S350). Here, the second terminal 200 may transmit the link establishment response message as a piggyback in the CTS message.

When the link establishment response message is successfully received, the first terminal 100 transmits successful reception (ACK) to the second terminal 200 (S360).

If a service flow setting is not included in the link establishment request message or if the first terminal 100 wants to additionally set a service flow, the first terminal 100 transmits a service setting message to the second terminal 200 (S370). The service setting message includes an in-order delivery indicator and a maximum time (SDU reordering timeout) with respect to a corresponding service flow.

When the CTS message is received from the second terminal 200, the first terminal 100 transmits PDUs to the second terminal 200.

With respect to a service flow requiring in-order delivery, the second terminal 200 restores SDUs from the PDUs received from the first terminal 100, and delivers the SDUs according to sequence numbers of the received PDUs in order to a higher layer.

If there is a PDU not received from the first terminal 100, the second terminal 200 waits the maximum time (SDU reordering timeout).

In this manner, the second terminal may deliver the SDUs in order to the higher layer with respect to the service flow requiring in-order delivery.

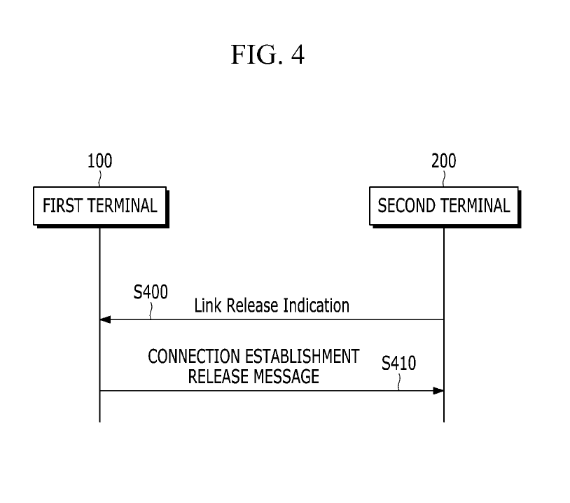

FIG. 4 is a view illustrating a method for releasing a unicast connection according to an embodiment of the present invention.

Referring to FIG. 4, in order to release an established connection, the first terminal 100 may transmit a connection establishment release command message to terminate an established connection.

However, for various reasons in terms of the characteristics of a wireless link, the established connection may be abnormally terminated, so a procedure for requesting release of a link by the second terminal 200 is required. Thus, the second terminal 200 delivers a link release indication message (S400), and the first terminal 100 transmits a connection establishment release message to terminate the established connection (S410).

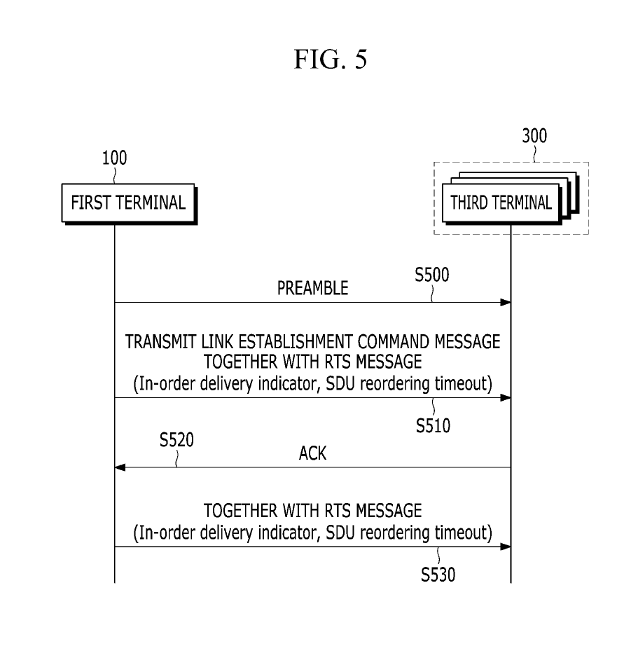

FIG. 5 is a view illustrating a method for establishing a one-hop broadcast and multicast connection for sequential SDU transmission according to an embodiment of the present invention.

Referring to FIG. 5, when the first terminal 100 wants to transmit PDUs to a plurality of reception terminals (destinations), i.e., to a plurality of third terminals 300, the first terminal 100 selects a single direct communication channel by using an interference avoidance algorithm and starts a broadcast and multicast link establishment procedure.

The first terminal 100 transmits a preamble to the plurality of third terminals 300 (S500).

Next, the first terminal 100 transmits a link establishment command message, together with an RTS message for indicating that data transmission is desired, to the plurality of third terminals 300 (S510).

Like the link establishment request message of FIG. 3, the link establishment command message may include a service flow setting. The link establishment command message may include an in-order delivery indicator and a maximum time (SDU reordering timeout) with respect to a corresponding service flow.

As the link establishment command message, an AAI-DC-LEST-CMD (Advanced Air Interface-Direct Communication-Link Establishment-Command) message of 802.16.1a/D2 AWD may be used.

Table 2 shows the AAI-DC-LEST-CMD message of 802.16.1a/D2 AWD.

As shown in Table 2, the AAI-DC-LEST-CMD message may additionally include an in-order delivery indicator and a maximum time (SDU reordering timeout) with respect to a corresponding service flow.

TABLE 2

| | Size | | |
|---|---|---|---|
| Field | (bits) | Value/Description | Condition |
| Link Change | 4 | The change count of | Shall |
| Count | | this transaction | always be |
| | | assigned by the | present |
| | | sender. If new | |
| | | transaction is started, | |
| | | Link Change Count is | |
| | | incremented by one | |
| | | (modulo 16) by the | |
| | | sender. | |
| For (i=0; | | N_Flow_Est is the | |
| i<N_Flow_Est; | | number of flows on | |
| i++) { | | which the sender of | |
| | | this message sends | |
| | | MAC PDUs. | |
| | | Range [0 . . . 1] | |
| FID | 4 | Flow identifier | |
| | | assigned by the source | |
| | | of packets on the flow | |
| Traffic Priority | 3 | 0 to 7: Higher numbers | |
| | | indicate higher priority | |
| | | Default: 0 | |
| CS | 8 | 0-15: Reserved | |
| Specification | | 16: Voice Codec | |
| Parameters | | G.729A | |
| | | 17: Voice Codec AMR | |
| | | 18-255: Reserved | |
| MAC Header | 1 | indicates whether | |
| Type | | AGMH or SPMH is | |
| | | presented at the start | |
| | | of MAC PDUs of the | |
| | | service flow. | |
| | | 0: AGMH (Advanced | |
| | | Generic MAC Header) | |
| | | 1: SPMH | |
| | | (Short-Packet MAC | |
| | | header) | |
| | | Default value is 0. | |
| In-order | 1 | Indicates whether or | |
| Delivery | | not the order of | |
| Indicator | | delivery in the | |
| | | connection is | |
| | | preserved | |
| | | by the MAC. | |
| | | 0: Not preserved | |
| | | 1: Preserved | |
| SDU | 3 | 0 > and <= 8, Unit is | Present if |
| Reordering | | DC frame | in-order |
| Timeout | | | delivery |
| | | | indicator |
| | | | is set 1 |
| Reserved | 4 | | |

When the plurality of third terminals 300 successfully receive the link establishment command message, they may or may not transmit successful reception (ACK) via an auxiliary channel (S520).

If a service flow setting is not included in the link establishment command message or if the first terminal 100 wants to additionally set a service flow, the first terminal 100 transmits a service setting message (S530). The service setting message includes an in-order delivery indicator and a maximum time (SDU reordering timeout) with respect to a corresponding service flow.

In case of a broadcast and multicast transmission, a dynamic service addition-command (DSA-CMD) message may be used as a service setting message. For example, an AAI-DC-DSA-CMD message of 802.16.1 a/D2 AWD may be used as a service setting message.

Table 3 shows the AAI-DC-DSA-CMD message of 802.16.1a/D2 AWD.

As shown in Table 3, the AAI-DC-DSA-CMD message may include an in-order delivery indicator, and a maximum time (SDU reordering timeout) with respect to a corresponding service flow.

TABLE 3

| | Size | | |
|---|---|---|---|
| Field | (bits) | Value/Description | Condition |
| FID Change | 4 | The change count of this | Shall always |
| Count | | transaction is assigned by | be present |
| | | the sender. If a new | |
| | | transaction is started, FID | |
| | | Change Count is | |
| | | incremented by one | |
| | | (modulo 16) by the | |
| | | sender. | |
| For (i=0; | | N_Flow_Est is the | |
| i<N_Flow_Est; | | number of flows on which | |
| i++) { | | the sender of this | |
| | | message sends MAC | |
| | | PDUs. | |
| FID | 4 | Flow identifier assigned | |
| | | by the source of packets | |
| | | on the flow | |
| Traffic Priority | 3 | 0 to 7: Higher numbers indicate | |
| | | higher priority | |
| | | Default: 0 | |
| CS | 8 | 0-15: Reserved | |
| Specification | | 16: Voice Codec G.729A | |
| Parameters | | 17: Voice Codec AMR | |
| | | 18-255: Reserved | |
| MAC Header | 1 | Indicates whether AGMH | |
| Type | | or SPMH is presented at | |
| | | the start of MAC PDUs of | |
| | | the service flow. | |
| | | 0: AGMH (Advanced | |
| | | Generic MAC Header) | |
| | | 1: SPMH (Short-Packet | |
| | | MAC header) | |
| | | Default value is 0. | |
| } | | | |
| In-order | 1 | Indicates whether or not | |
| Delivery | | the order of | |
| Indicator | | delivery in the | |
| | | connection is preserved | |
| | | by the MAC. | |
| | | 0: Not preserved | |
| | | 1: Preserved | |
| SDU | 3 | 0 > and <= 8, Unit is DC | Present if |
| Reordering | | frame | In-order |
| Timeout | | | Delivery |
| | | | Indicator is |
| | | | set to 1 |
| Reserved | 4 | | |

The first terminal transmits PDUs to the plurality of third terminals 300.

With respect to a service flow requiring in-order delivery, the plurality of third terminals 300 restore SDUs from the PDUs received from the first terminal 100, and deliver the SDUs according to sequence numbers of the received PDUs in order to a higher layer.

If there is a PDU not received from the first terminal 100, the plurality of third terminals 300 waits the maximum time (SDU reordering timeout).

Meanwhile, unlike the cases of FIGS. 3 through 5, the first terminal 100 and the reception terminal (200 in FIG. 2 or 300 in FIG. 5) may be connected through a relay. In a case in which the first terminal 100 and the reception terminal (200 in FIG. 2 or 300 in FIG. 5) are set for a two-hop connection using a relay, an operation setting different from that of the operation as described above is required.

First, when the first terminal 100 wants to transmit a PDU to a reception terminal, the first terminal 100 may transmit a request for in-order delivery to a relay or a reception terminal. When the first terminal 100 requests in-order delivery from the relay, the relay may restore SDUs from the PDUs received from the first terminal 100, configure a new MAC PDU in order based on the SDUs, and transmit the same to the reception terminal.

Meanwhile, when the first terminal 100 requests in-order delivery from the reception terminal, the operation of the reception terminal is the same as that of the second terminal 200 and the third terminal 300 as described above with reference to FIGS. 3 and 5.

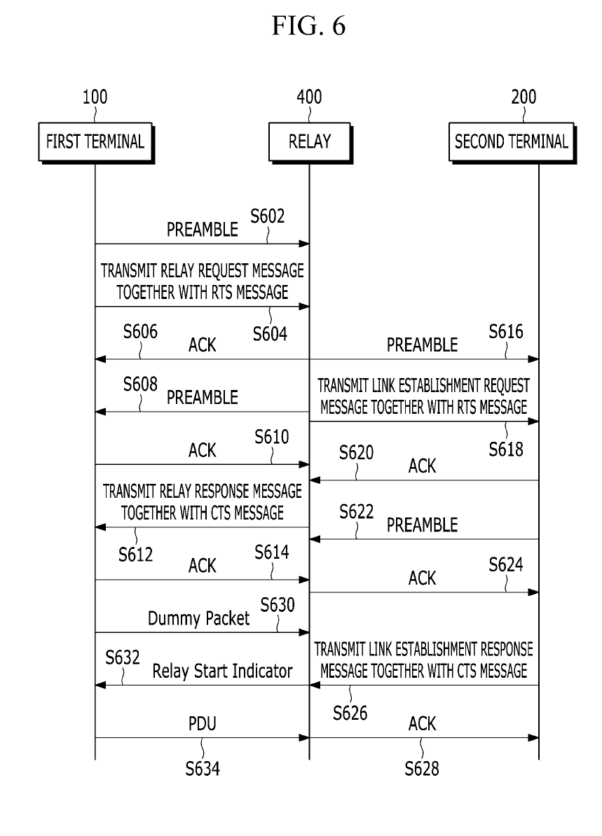

FIG. 6 is a view illustrating a method for establishing a two-hop unicast connection for sequential SDU transmission according to an embodiment of the present invention.

Referring to FIG. 6, the first terminal 100 selects a single direct communication channel by using an interference avoidance algorithm and starts a unicast link establishment procedure for the relay 400.

The first terminal 100 transmits a preamble (S602), and transmits a relay request message, together with an RTS message for indicating that data transmission is desired, to the relay 400 (S604).

The relay request message may include a service flow setting. Here, the first terminal may request in-order delivery from the relay 400 or the second terminal 200 through the relay request message.

The relay request message may include an in-order delivery indicator and a maximum time (SDU reordering timeout) with respect to a corresponding service flow, a target in-order delivery indicator, and target maximum time (target SDU reordering timeout). In case of a two-hop connection, the first terminal 100 may instruct the relay 400 or the second terminal 200 to perform in-order delivery. The in-order delivery indicator and the maximum time (SDU reordering timeout) are parameters for the first terminal 100 to instruct the relay 400 to perform in-order delivery, and the target in-order delivery indicator and the target maximum time (target SDU reordering timeout) are parameters for the first terminal to instruct the second terminal 200 to perform in-order delivery.

As the relay request message, an AAI-DC-RELAY-REQ message of 802.16.1a/D2 AWD may be used.

Table 4 shows the AAI-DC-RELAY-REQ message of 802.16.1a/D2 AWD.

As shown in Table 4, the AAI-DC-RELAY-REQ may additionally include an in-order delivery indicator and a maximum time (SDU reordering timeout) with respect to a corresponding service flow, and a target of an in-order delivery request (target address type), a target in-order delivery indicator, and a target maximum time (target SDU reordering timeout).

TABLE 4

| | Size | | |
|---|---|---|---|
| Field | (bits) | Value/Description | Condition |
| Link Change | 4 | The change count of | Shall |
| Count | | this transaction | always be |
| | | assigned by the | present |
| | | sender. If new | |
| | | transaction is started, | |
| | | Link Change Count is | |
| | | incremented by one | |
| | | (modulo 16) by the | |
| | | sender. | |
| For (i=0; | | N_Flow_Est is the | |
| i<N_Flow_Est; | | number of flows on | |
| i++) { | | which the sender of | |
| | | this message sends | |
| | | MAC PDUs. | |
| | | Range [0 . . . 1] | |
| FID | 4 | Flow identifier | |
| | | assigned by the sink | |
| | | of packets on the flow | |
| Traffic Priority | 3 | 0 to 7: Higher | |
| | | numbers indicate | |
| | | higher priority | |
| | | Default: 0 | |
| CS | 8 | 0-15: Reserved | |
| Specification | | 16: Voice Codec | |
| Parameters | | G.729A | |
| | | 17: Voice Codec | |
| | | AMR | |
| | | 18-255: Reserved | |
| MAC Header | 1 | Indicates whether | |
| Type | | AGMH or SPMH is | |
| | | presented at the start | |
| | | of MAC PDUs of the | |
| | | service flow. | |
| | | 0: AGMH (Advanced | |
| | | Generic MAC | |
| | | Header) | |
| | | 1: SPMH | |
| | | (Short-Packet MAC | |
| | | header) | |
| | | Default value is 0. | |
| In-order | 1 | Indicates whether or | |
| Delivery | | not the order of | |
| Indicator | | delivery in the | |
| | | connection is | |
| | | preserved | |
| | | by the MAC. | |
| | | 0: Not preserved | |
| | | 1: Preserved | |
| SDU | 3 | 0 > and <= 8, Unit is | Present if |
| Reordering | | DC frame | In-order |
| Timeout | | | Delivery |
| | | | Indicator |
| | | | is set to 1 |
| } | | | |
| Target DCTID | 24 | Indicates a receiving | |
| or DCGID | | HR-MS (Group) | |
| | | address. | |
| Target | 1 | Indicates type of | |
| Address Type | | destination | |
| | | address. | |
| | | 0: DCTID | |
| | | 1: DCGID | |
| Target | 1 | Indicates whether or | |
| In-order | | not the order of | |
| Delivery | | delivery in the | |
| Indicator | | connection is | |
| | | preserved | |
| | | by the MAC. | |
| | | 0: Not preserved | |
| | | 1: Preserved | |
| Target SDU | 3 | 0 > and <= 8, Unit is | Present if |
| Reordering | | DC frame | In-order |
| Timeout | | | Delivery |
| | | | Indicator |
| | | | is set to 1 |
| Reserved | 3 | | |

When the relay request message is successfully received, the relay 400 transmits successful reception (ACK) via an auxiliary channel (S606) and transmits a preamble to the first terminal 100 (S608).

Next, when successful reception (ACK) of the preamble is received from the first terminal 100 (S610), the relay 400 transmits a relay response message with respect to the relay request message, together with a CTS message for indicating approval of data transmission, to the first terminal 100 (S612).

When the relay response message is successfully received, the first terminal 100 transmits successful message reception (ACK) to the relay 400 (S614).

The relay 400 performs a procedure for establishing a unicast connection with a reception terminal (Target DCTID), i.e., the second terminal 200, included in the relay request message (S616 to S628). Here, the procedure (S616 to S628) for establishing a unicast connection between the relay 400 and the second terminal 200 is the same as the procedure (S300 to S360) for establishing a unicast connection between the first terminal 100 and the second terminal 200 as described above with reference to FIG. 3.

However, the relay 400 transmits the parameters, i.e., the in-order delivery indicator and the maximum time (SDU reordering timeout) with respect to the corresponding service flow, the target of the in-order delivery request (target address type), the target in-order delivery indicator, and the target maximum time (target SDU reordering timeout) related to the in-order delivery request received from the relay request message, in relation to the in-order delivery request received from the relay request message by using a connection establishment request message.

Also, the relay 400 may set a flow identifier with the second terminal 200 such that it is the same as that of the first terminal 100 or such that it is different from that of the first terminal 100. The flow identifier identifies a packet flow, a flow identifier between the first terminal 100 and the relay 400 is determined by the first terminal 100, and a flow identifier between the relay 400 and the second terminal 200 is determined by the relay 400. Such a flow identifier is included in a MAC header.

If the flow identifier between the first terminal 100 and the relay 400 and that between the relay 400 and the second terminal 200 are different, the relay 400 may correct a flow identifier value in a MAC header of a MAC PDU generated by the first terminal 100 and transmit the corrected flow identifier value to the second terminal 200.

In the procedure for establishing a unicast connection through the relay 400, establishment of a connection between the relay 400 and the first terminal is completed and a PDU is ready to be transmitted, but establishment of a connection between the relay 400 and the second terminal 200 may not be completed or may be failed. The relay 400 may send the first terminal 100 feed back on the connection status with second terminal 200.

Namely, in a case in which a connection establishment between the relay 400 and the second terminal 200 is completed later than a connection establishment between the first terminal 100 and the relay 400, the relay 400 may send the first terminal 100 a relay link preparation complete notification message (Relay Start Indicator) indicating completion of connection establishment with the second terminal 200 (S632), which means preparation of a relay link is completed.

Table 5 shows sequences of feedback channels and mapping defined in 802.16.1a/D2 AWD.

TABLE 5

| Index | Sequence | Usage |
|---|---|---|
| 0 | 1111111111 | ACK |
| 1 | 0010110001 | NAK for frame 0 |
| 2 | 0100100110 | NAK for frame 1 |
| 3 | 1001101000 | NAK for frame 2 |
| 4 | 1011000100 | NAK for frame 3 |
| 5 | 0110001010 | MCS Change Confirm |
| 6 | 0000011101 | RCHG Request Indication |
| 7 | 1101010011 | Send Indication |
| 8 | 1100011000 | Token Request Indication |
| 9 | 0001010110 | Relay Start Indication |
| 10 | 0111000001 | Link Release Indication |
| 11 | 1010001111 | Reserved |
| 12 | 1000100011 | Reserved |
| 13 | 0101101101 | Reserved |
| 14 | 0011111010 | Reserved |
| 15 | 1110110100 | Reserved |

As illustrated in Table 5, as a link preparation complete notification message (Relay Start Indicator), a sequence “0001010110” of a feedback channel may be used, and as a link release notification message (Link Release Indication), a sequence “0111000001” of a feedback channel may be used. In this case, the sequences may be transmitted in a PHY.

When the relay preparation complete notification message is received, the first terminal 100 starts to transmit PDUs (S634).

Until the link preparation complete notification message is received from the relay 400, the first terminal may transmit virtual data (a dummy packet) (S630) in order to maintain channel occupancy, rather than transmitting a PDU.

Upon receiving the virtual data (dummy packet), the relay 400 transmits HARQ results with respect to the corresponding data and discards received data.

Meanwhile, in a case in which a connection establishment between the relay 400 and the second terminal 200 fails, the relay 400 may transfer a link release notification message (Link Release Indication) indicating failure of a relay connection to the first terminal 100, and the first terminal 100 may transmit a connection establishment release command message to the relay 400 in order to terminate the established connection, thereby terminating the established connection with the relay 400.

Meanwhile, when a service flow setting is not included in the relay request message or when a service flow is to be additionally set, the first terminal 100 may transmit a service setting message to the relay 400. Like the relay request message, the service setting message may include an in-order delivery indicator indicating whether a corresponding service flow requires in-order delay in the relay 400 or the second terminal 200, and a maximum time (SDU reordering timeout), a target in-order delivery indicator, and a target maximum time (target SDU reordering timeout).

When the first terminal requests in-order delivery from the relay 400, the relay 400 restores SDUs from the PDUs received from the first terminal 100, generates new MAC PDUs in order of the SDUs, and transmits the generated new MAC PDUs to the second terminal 200.

If there is a PDU not yet received from the first terminal, the relay 400 transmits virtual data (dummy packet) to the second terminal 200, and after the lapse of the maximum time (SDU reordering timeout), the relay 400 transmits a next PDU.

In a case in which the first terminal 100 does not request in-order delivery from the relay 400, the relay 400 transmits the received PDUs to the second terminal 200. Here, when a flow identifier between the first terminal 100 and the relay 400 and a flow identifier between the relay 400 and the second terminal 200 are identical, the relay 400 may transmit the PDUs received from the first terminal 100 as is to the second terminal 200. However, when the flow identifier between the first terminal 100 and the relay 400 and the flow identifier between the relay 400 and the second terminal 200 are different, the relay 400 may correct the flow identifier value in a MAC header of the MAC PDU generated by the first terminal 100 and transmit the corrected flow identifier value.

Meanwhile, in a case in which the first terminal 100 requests in-order delivery from the second terminal 200, the second terminal 200 restores SDUs from the PDUs with respect to a required service flow, and delivers the restored SDUs to a higher layer in order.

If there is a PDU not yet received from the first terminal 100, the second terminal 200 waits the maximum time (SDU reordering timeout).

In a case in which the first terminal 100 does not request in-order delivery from the second terminal 200, the second terminal 200 may immediately transmit corresponding SDUs to a higher layer regardless of order when the received PDUs are decoded.

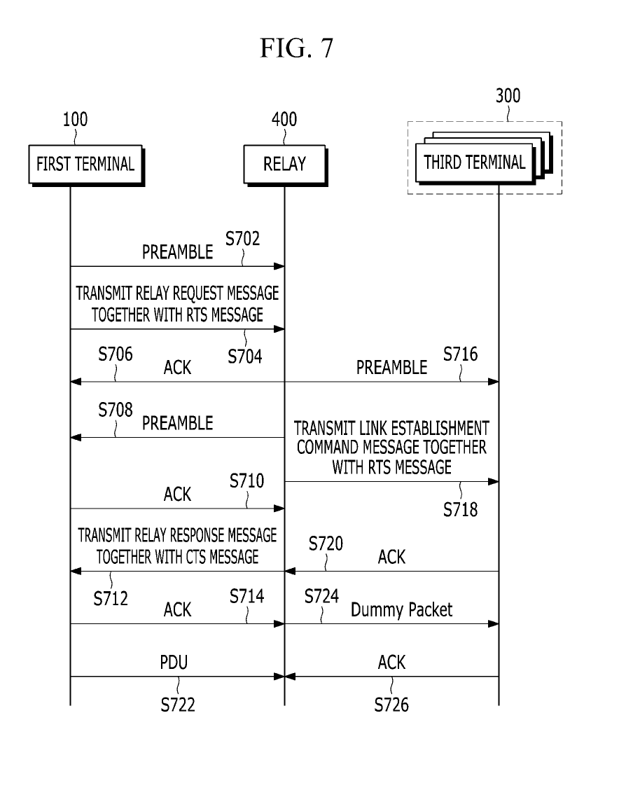

FIG. 7 is a view illustrating a method for establishing a two-hop broadcast and multicast connection for sequential SDU transmission according to an embodiment of the present invention.

Referring to FIG. 7, the first terminal 100 selects a single direct communication channel by using an interference avoidance algorithm, and starts a procedure for establishing a broadcast and multicast link with the relay 400.

The first terminal transmits a preamble (S702) and a relay request message together with an RTS message indicating that data transmission is desired to the relay 400 (S704). When a receiver ID type (Destination Address Type) of the relay request message is broadcast and multicast, it means that broadcast and multicast link establishment is requested.

The relay request message may include a service flow setting. In this case, the first terminal 100 may request in-order delivery from the relay 400 or the plurality of terminals 300 through a relay request message.

As described above with reference to FIG. 6, the relay request message includes an in-order delivery indicator and a maximum time (SDU reordering timeout) with respect to a corresponding service flow, a target in-order delivery indicator, and a target maximum time (Target SDU Reordering Timeout).

When the relay request message is successfully received, the relay 400 transmits a successful message reception (ACK) via an auxiliary channel (S706) and transmits a preamble to the first terminal (S708).

Meanwhile, when the relay request message is received from the first terminal 100, the relay 400 performs a procedure for establishing a broadcast and multicast connection with the reception terminals (Target DCTID), i.e., the plurality of third terminals 300, included in the relay request message (S716 to S720). Here, the procedure (S716 to S720) for establishing a broadcast and multicast connection of the relay 400 and the plurality of third terminals 300 is the same as the procedure (S500 to S520) for establishing a broadcast and multicast connection of the first terminal 100 and the second terminal 200. However, the relay 400 transmits a parameter in relation to the request for in-order delivery received from the relay request message, by using a connection establishment command message.

The relay 400 may set the flow identifier with the plurality of third terminals 300 such that it is the same as that of the first terminal 1001 or such that it is different from that of the first terminal 100.

When the relay 400 receives successful reception (ACK) of the preamble from the first terminal 100 (S710) and receives successful reception (ACK) with respect to the link establishment command message from the plurality of third terminals 300, the relay 400 transmits a relay response message with respect to the relay request message, together with a CTS message indicating approval of data transmission, to the first terminal 100 (S712).

When the relay response message is successfully received, the first terminal 100 transmits successful reception (ACK) to the relay 400 (S714).

If a service flow setting is not included in the relay request message, or when a service flow is to be additionally set, the first terminal 100 may transmit a service setting message.

After transmitting the acknowledgement (ACK) to the relay 400 (S714), the first terminal starts to transmit PDUs (S722).

In a case in which the first terminal 100 requests in-order delivery from the relay 400, the relay 400 restores SDUs from the PDUs received from the first terminal 100, generates new MAC PDUs in order of the SDUs, and transmits the newly generated MAC SDUs to the plurality of third terminals 300.

If there is a PDU not yet received from the first terminal 100, the relay 400 waits the maximum time (SDU reordering timeout).

In a case in which the first terminal 100 does not request in-order delivery from the relay 400, the relay 400 transmits the received PDUs to the plurality of third terminals 300. In this case, when a flow identifier between the first terminal 100 and the relay 400 and a flow identifier between the relay 400 and the plurality of third terminals 300 are identical, the relay 400 may transmit the PDUs received from the first terminal 100 as is to the third terminals 300. However, when the flow identifier between the first terminal 100 and the relay 400 and the flow identifier between the relay 400 and the plurality of third terminals 300 are different, the relay 400 may correct the flow identifier value in a MAC header of the MAC PDU generated by the first terminal 100 and transmit the corrected flow identifier value.

Meanwhile, in a case in which the first terminal 100 requests in-order delivery from the plurality of third terminals 300, the plurality of third terminals 300 restore SDUs from the PDUs with respect to a required service flow, and deliver the restored SDUs to a higher layer in order.

If there is a PDU not yet received from the first terminal 100, the plurality of third terminals 300 wait the maximum time (SDU reordering timeout).

In a case in which the first terminal 100 does not request in-order delivery from the plurality of third terminals 300, the plurality of third terminals 300 may immediately transmit corresponding SDUs to a higher layer regardless of order when the received PDUs are decoded.

Meanwhile, the relay 400 may transmit virtual data (a dummy packet) to the plurality of third terminals 300 in order to maintain channel occupancy (S724).

When the virtual data (dummy packet) is received, the plurality of third terminals 300 may transmit HARQ results (ACK) with respect to the corresponding data (S726) and discard the received data.

According to an embodiment of the present invention, terminals participating in direct communication can provide an in-order delivery function according to a service in the event of one-hop or two-hop connection.

The embodiments of the present invention may not necessarily be implemented only through the foregoing devices and/or methods, but may also be implemented through a program for realizing functions corresponding to the configurations of the embodiments of the present invention, a recording medium including the program, or the like, and such implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for sequentially transmitting data to a higher layer in a reception terminal, the method comprising:
receiving an in-order delivery indicator indicating whether a service flow requires in-order delivery and a maximum time during which data not yet received is to wait in a case in which in-order delivery is required, from a transmission terminal;
restoring service data units (SDUs) from protocol data units (PDUs) received from the transmission terminal with respect to the service flow; and
transmitting the restored SDUs to the higher layer in order according to sequence numbers of the received PDUs.

2. The method of claim 1, wherein when there is a PDU not yet received from the transmission terminal, the maximum time is awaited.

3. The method of claim 1, wherein the receiving includes receiving a link establishment request message for establishing a link from the transmission terminal,
wherein the link establishment request message includes the in-order delivery indicator and the maximum time.

4. The method of claim 3, further comprising
transmitting a link establishment response message with respect to the link establishment request message to the transmission terminal.

5. The method of claim 4, wherein the receiving of the link establishment request message includes receiving a request to send (RTS) message indicating that data transmission from the transmission terminal is desired,
the transmitting of the link establishment response message includes transmitting a clear to send (CTS) message indicating approval of the data transmission to the transmission terminal,
the link establishment request message is piggybacked to the RTS message, and the link establishment response message is piggybacked to the CTS message.

6. The method of claim 3, wherein the link establishment includes unicast link establishment.

7. The method of claim 1, wherein the receiving includes receiving a link establishment command message for establishing a link from the transmission terminal, and
the link establishment command message includes the in-order delivery indicator and the maximum time.

8. The method of claim 7, wherein the receiving of the link establishment command message includes receiving an RTS message indicating that data transmission is desired from the transmission terminal, and
the link establishment request message is piggybacked to the RTS message.

9. The method of claim 7, wherein the link establishment includes broadcast and multicast link establishment.

10. The method of claim 1, wherein the receiving includes receiving a service setting message from the transmission terminal, and the service setting message includes the in-order delivery indicator and the maximum time.

11. The method of claim 1, further comprising
requesting release of the link connection established between the transmission terminal and the reception terminal.

12. A method for sequentially transmitting data to a higher layer in a reception terminal, the method comprising:
receiving an in-order delivery indicator indicating whether a service flow requires in-order delivery and a maximum time during which a protocol data unit (PDU) not yet received is to wait in a case in which in-order delivery is required, from a transmission terminal via a relay;
restoring service data units (SDUs) from protocol data units (PDUs) received via the relay with respect to the service flow; and
transmitting the restored SDUs to the higher layer in order.

13. The method of claim 12, wherein the receiving includes receiving a target of in-order delivery from the transmission terminal via the relay.

14. The method of claim 13, wherein the restoring includes, when the target of the in-order delivery is the relay, receiving PDUs generated again in sequence of SDUs from the relay which has received the PDUs transmitted by the transmission terminal.

15. The method of claim 13, wherein the restoring includes:
when the target of the in-order delivery is the reception terminal, receiving the PDUs transmitted from the transmission terminal via the relay; and
restoring SDUs from the received PDUs and sorting the restored SDUs in order.

16. The method of claim 15, wherein the restoring further includes, when there is a PDU not yet received from the transmission terminal via the relay, waiting the maximum time.

17. The method of claim 12, wherein the receiving includes receiving a link establishment request message for establishing a unicast link from the relay which has received a relay request message from the transmission terminal,
wherein the relay request message and the link establishment request message include the in-order delivery indicator and the maximum time, respectively.

18. The method of claim 17, further comprising
transmitting a link establishment response message with respect to the link request message to the relay,
wherein when a link establishment between the relay and the reception terminal is completed, the PDU is transmitted from the transmission terminal.

19. The method of claim 12, wherein the receiving includes receiving a link establishment command message for establishing a broadcast and multicast links from the relay which has received a relay request message from the transmission terminal,
wherein the relay request message and the link establishment command message include the in-order delivery indicator and the maximum time, respectively.

20. The method of claim 19, further comprising
transmitting a reception acknowledgement message with respect to the link establishment command message to the relay,
wherein when a link establishment between the relay and the reception terminal is completed, the PDU is transmitted from the transmission terminal.
